(19) United States
(12) Patent Application Publication
(10) Pub. No.: US 2014/0200718 A1
(43) Pub. Date: Jul. 17, 2014

(54) SYSTEMS AND METHODS FOR FACILITATING DIAGNOSTIC TESTING OF AN HVAC SYSTEM

(71) Applicant: HONEYWELL INTERNATIONAL INC., Morristown, NJ (US)

(72) Inventor: Patrick C. Tessier, Maple Grove, MN (US)

(73) Assignee: HONEYWELL INTERNATIONAL INC., Morristown, NJ (US)

(21) Appl. No.: 13/743,163

(22) Filed: Jan. 16, 2013

(51) Int. Cl. G05D 23/19

(52) U.S. Cl. CPC G05D 23/19
USPC 700/276

(57) ABSTRACT

An HVAC controller is configured to transmit a service request to a service provider over a network. In some cases, the service request may contain information that is indicative of the performance of the HVAC system. Upon receiving the service request, the service provider may send an acknowledgement that the request has been received. The acknowledgement may be delivered to as an email or text message to a user's remote device or, in some cases, may be displayed on the user interface of the HVAC controller.

### TECHNICAL FIELD

The present disclosure relates generally to HVAC systems, and more particularly to systems and methods that facilitate diagnostic testing of an HVAC system.

### BACKGROUND

Heating, ventilation, and/or air conditioning (HVAC) systems are often used to control the comfort level within a building or other structure. Such HVAC systems typically include an HVAC controller that controls various HVAC components of the HVAC system in order to affect and/or control one or more environmental conditions within the building. In some cases, it may be desirable to perform diagnostic testing of one or more of the HVAC components of the HVAC system, sometimes upon a user's request.

### SUMMARY

The present disclosure relates generally to HVAC systems, and more particularly to systems and methods that facilitate diagnostic testing of an HVAC system. In one illustrative embodiment, a building controller for controlling one or more HVAC components of an HVAC system may include an input/output port for sending and/or receiving information over a network and a controller in communication with the input/output port. The controller may be configured to receive a request for service from a user via a user interface. Upon receiving the request for service, the controller may transmit a first data package to a service provider via the input/output port of the HVAC controller. In some cases, the first data package may include information that is, at least in part, indicative of a measure of performance of one or more components of the HVAC system.

In some cases, a remote device may be configured to communicate with an HVAC controller of an HVAC system. The remote device may include, for example, a remotely located computer such as a desktop computer, a lap top computer, a tablet computer, a smart phone, a server, and/or any other remote device, as desired. The remote device may include an input/output port for sending and/or receiving information via a network, a memory, a user interface, and a controller coupled to the input/output port, the memory and the user interface. The controller may be configured to receive a requesting for service from a user via the user interface of the remote device, wherein upon receiving the requesting for service, the controller of the remote device may transmit the request for service via the input/output port so that the request for service is deliverable to the HVAC controller and/or a service provider. The controller may be further configured to receive an acknowledgement via the input/output port of the remote device that the request for service was sent to a service provider.

In illustrative method for testing an HVAC system may include receiving a first data package transmitted by an HVAC controller at a remote device. The first data package may include information indicative of a measure of performance of at least one of the one or more HVAC components. The information indicative of the performance of the at least one HVAC component may be displayed on a display of the remote device, and a second data package may be transmitted from the remote device to the HVAC controller. The second data package may confirm that the first data package was received by the remote device, and may contain instructions that cause the HVAC controller to display an indicator that the first data package was received by the remote device.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following detailed description of various embodiments in connection with the accompanying drawings, in which:

FIG. 1 is a schematic view of an illustrative HVAC system servicing a building or structure;

FIG. 2 is a schematic view of an illustrative HVAC control system that may facilitate access and/or control of the HVAC system of FIG. 1;

FIG. 3 is a schematic block diagram of an illustrative HVAC controller;

FIG. 4 is a schematic view of an illustrative user interface that may be provided with the illustrative HVAC controller of FIG. 3;

FIG. 5 is a schematic view of another illustrative user interface that may be provided with the HVAC controller of FIG. 3;

FIGS. 6 and 7 are illustrative screens that may be displayed by the illustrative user interface of FIG. 5;

FIG. 8 is an exemplary web page that may form at least a part of a virtual user interface that may be used by a user to interact with the illustrative HVAC controller of FIG. 3;

FIGS. 9 and 10 are schematic block diagrams of illustrative remote devices that may be used to communicate with and/or control the illustrative HVAC controller of FIG. 3;

FIG. 11 is a schematic block diagram of an illustrative server that may be used to communicate with the illustrative HVAC controller of FIG. 3;

FIGS. 12-14 provide illustrative examples of user messages that may be displayed by the user interface of the illustrative HVAC controller of FIG. 3; and

FIG. 15 is a flow chart of an illustrative method of testing an HVAC system.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements throughout the several views. The description and drawings show several embodiments which are meant to illustrative in nature.

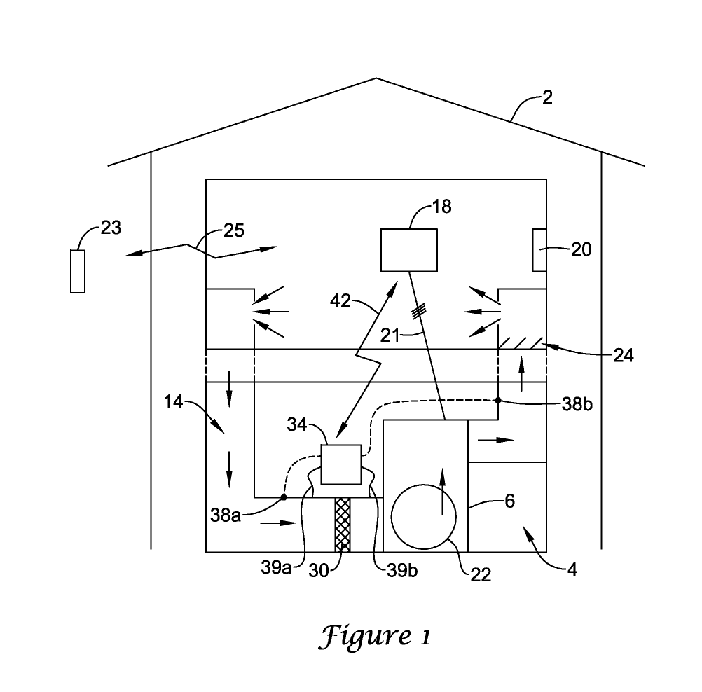

FIG. 1 is a schematic view of a building 2 having an illustrative heating, ventilation, and air conditioning (HVAC) system 4. While FIG. 1 shows a typical forced air type HVAC system, other types of HVAC systems are contemplated including, but not limited to, boiler systems, radiant heating systems, electric heating systems, cooling systems, heat pump systems, and/or any other suitable type of HVAC system, as desired. The illustrative HVAC system 4 of FIG. 1 includes one or more HVAC components 6, a system of ductwork and air vents including a supply air duct 10 and a return air duct 14, and one or more HVAC controllers 18. The one or more HVAC components 6 may include, but are not limited to, a furnace, a heat pump, an electric heat pump, a geothermal heat pump, an electric heating unit, an air conditioning unit, a humidifier, a dehumidifier, an air exchanger, an air cleaner, a damper, a valve, and/or the like.

It is contemplated that the HVAC controller(s) 18 may be configured to control the comfort level in the building or structure by activating and deactivating the HVAC component(s) 6 in a controlled manner. The HVAC controller(s) 18 may be configured to control the HVAC component(s) 6 via a wired or wireless communication link 21. In some cases, the HVAC controller(s) 18 may be a thermostat, such as, for example, a wall mountable thermostat, but this is not required in all embodiments. Such a thermostat may include (e.g. within the thermostat housing) or have access to a temperature sensor for sensing an ambient temperature at or near the thermostat. In some instances, the HVAC controller(s) 18 may be a zone controller, or may include multiple zone controllers each monitoring and/or controlling the comfort level within a particular zone in the building or other structure.

An illustrative HVAC controller, which is not meant to be limiting in any way, is disclosed in: US Published Patent Application No. 20090140062, entitled “HVAC CONTROLLER THAT SELECTIVELY REPLACES OPERATING INFORMATION ON A DISPLAY WITH SYSTEM STATUS INFORMATION”; US Published Application No. 20090143880, entitled “HVAC CONTROLLER WITH CONTEXT SENSITIVE HELP SCREENS”; US Published Application No. 20090143918, entitled “METHOD AND APPARATUS FOR CONFIGURING AN HVAC CONTROLLER”; US Published Application No. 20090143916, entitled “HVAC CONTROLLER HAVING A PARAMETER ADJUSTMENT ELEMENT WITH A QUALITATIVE INDICATOR”; US Published Application No. 20090143879, entitled “HVAC CONTROLLER WITH PARAMETER CLUSTERING”; US Published Application No. 20090140056, entitled “HVAC CONTROLLER WITH QUICK SELECT FEATURE,” the entireties of which are incorporated herein by reference for all purposes.

In some cases, the HVAC system 4 may include an internet gateway or other device 20 that may permit the HVAC controller 18, as described herein, to communicate over a wired or wireless network 25 with a remote device 23. A non-limiting example of a gateway device is Honeywell Inc.'s REDLINK™ internet gateway. In some cases, the network 25 may be a wireless local area network (WLAN) or a wide area network (WAN) such as, for example, the Internet. The remote device 23 may be used to communicate with and/or control the HVAC controller(s) 18 from a remote location outside of and away from the building 2. The remote device 23 may be any one of a mobile phone including a smart phone, a PDA, a tablet computer, a laptop or personal computer, an e-Reader, and/or the like. These are just some examples.

In the illustrative HVAC system 4 shown in FIG. 1, the HVAC component(s) 6 may provide heated air (and/or cooled air) via the ductwork throughout the building 2. As illustrated, the HVAC component(s) 6 may be in fluid communication with every room and/or zone in the building 2 via the ductwork 10 and 14, but this is not required. In operation, when a heat call signal is provided by the HVAC controller(s) 18, an HVAC component 6 (e.g. forced warm air furnace) may be activated to supply heated air to one or more rooms and/or zones within the building 2 via supply air ducts 10. The heated air may be forced through supply air duct 10 by a blower or fan 22. In this example, the cooler air from each zone may be returned to the HVAC component 6 (e.g. forced warm air furnace) for heating via return air ducts 14. Similarly, when a cool call signal is provided by the HVAC controller(s) 18, an HVAC component 6 (e.g. air conditioning unit) may be activated to supply cooled air to one or more rooms and/or zones within the building or other structure via supply air ducts 10. The cooled air may be forced through supply air duct 10 by the blower or fan 22. In this example, the warmer air from each zone may be returned to the HVAC component 6 (e.g. air conditioning unit) for cooling via return air ducts 14.

In some cases, the system of vents or ductwork 10 and/or 14 can include one or more dampers 24 to regulate the flow of air, but this is not required. For example, one or more dampers 24 may be coupled to one or more HVAC controller(s) 18, and can be coordinated with the operation of one or more HVAC components 6. The one or more HVAC controller(s) 18 may actuate dampers 24 to an open position, a closed position, and/or a partially open position to modulate the flow of air from the one or more HVAC components to an appropriate room and/or zone in the building or other structure. The dampers 24 may be particularly useful in zoned HVAC systems, and may be used to control which zone(s) receives conditioned air from the HVAC component(s) 6.

In many instances, one or more air filters 30 may be used to remove dust and other pollutants from the air inside the building 2. In the illustrative example shown in FIG. 1, the air filter(s) 30 is installed in the return air duct 14, and may filter the air prior to the air entering the HVAC component 6, but it is contemplated that any other suitable location for the air filter(s) 30 may be used. The presence of the air filter(s) 30 may not only improve the indoor air quality, but may also protect the HVAC components 6 from dust and other particulate matter that would otherwise be permitted to enter the HVAC component.

In some cases, and as shown in FIG. 1, the illustrative HVAC system 4 may include an equipment interface module (EIM) 34. When provided, the equipment interface module 34 may be configured to measure or detect a change in a given parameter between the return air side and the discharge air side of the HVAC system 4. For example, the equipment interface module 34 may be adapted to measure a difference in temperature, flow rate, pressure, or a combination of any one of these parameters between the return air side and the discharge air side of the HVAC system 4. In some cases, the equipment interface module 34 may be adapted to measure the difference or change in temperature (delta T) between a return air side and discharge air side of the HVAC system 4 for the heating and/or cooling mode. The delta T for the heating mode may be calculated by subtracting the return air temperature from the discharge air temperature (e.g. delta T=discharge air temp.−return air temp.). For the cooling mode, the delta T may be calculated by subtracting the discharge air temperature from the return air temperature (e.g. delta T=return air temp.−discharge air temp.).

In some cases, the equipment interface module 34 may include a first temperature sensor 38a located in the return (incoming) air duct 14, and a second temperature sensor 38b located in the discharge (outgoing or supply) air duct 10. Alternatively, or in addition, the equipment interface module 34 may include a differential pressure sensor including a first pressure tap 39a located in the return (incoming) air duct 14, and a second pressure tap 39b located downstream of the air filter 30 to measure a change in a parameter related to the amount of flow restriction through the air filter 30. In some cases, the equipment interface module 34, when provided, may include at least one flow sensor that is capable of providing a measure that is related to the amount of air flow restriction through the air filter 30. In some cases, the equipment interface module 34 may include an air filter monitor. These are just some examples.

When provided, the equipment interface module 34 may be configured to communicate with the HVAC controller 18 via, for example, a wired or wireless communication link 42. In other cases, the equipment interface module 34 may be incorporated or combined with the HVAC controller 18. In either cases, the equipment interface module 34 may communicate, relay or otherwise transmit data regarding the selected parameter (e.g. temperature, pressure, flow rate, etc.) to the HVAC controller 18. In some cases, the HVAC controller 18 may use the data from the equipment interface module 34 to evaluate the system's operation and/or performance. For example, the HVAC controller 18 may compare data related to the difference in temperature (delta T) between the return air side and the discharge air side of the HVAC system 4 to a previously determined delta T limit stored in the HVAC controller 18 to determine a current operating performance of the HVAC system 4.

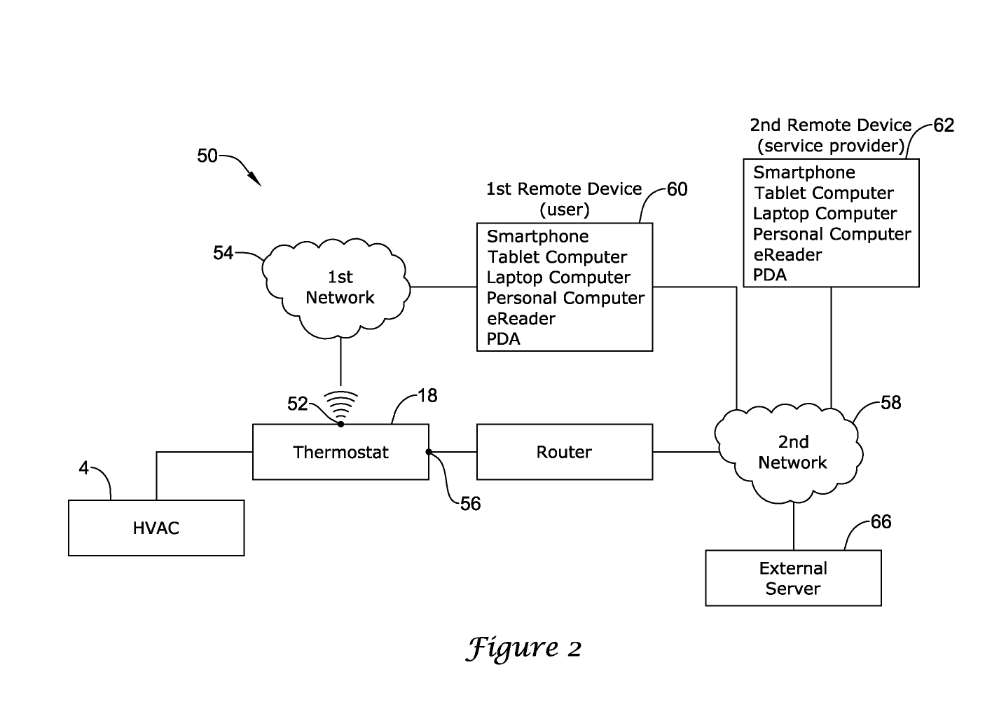

FIG. 2 is a schematic view of an illustrative HVAC control system 50 that facilitates remote access and/or control of the HVAC system 4 shown in FIG. 1. The illustrative HVAC control system 50 includes an HVAC controller, such as for example, HVAC controller 18 (see

FIG. 1) that is configured to communicate with and control one or more components 6 of the HVAC system 4. As discussed above, the HVAC controller 18 may communicate with the one or more components 6 of the HVAC system 4 via a wired or wireless link. Additionally, the HVAC controller 18 may be adapted to communicate over one or more wired or wireless networks that may accommodate remote access and/or control of the HVAC controller 18 via one or more remote devices including, but not limited to, mobile phones including smart phones, PDAs, tablet computers, laptop or personal computers, e-Readers, and/or the like.

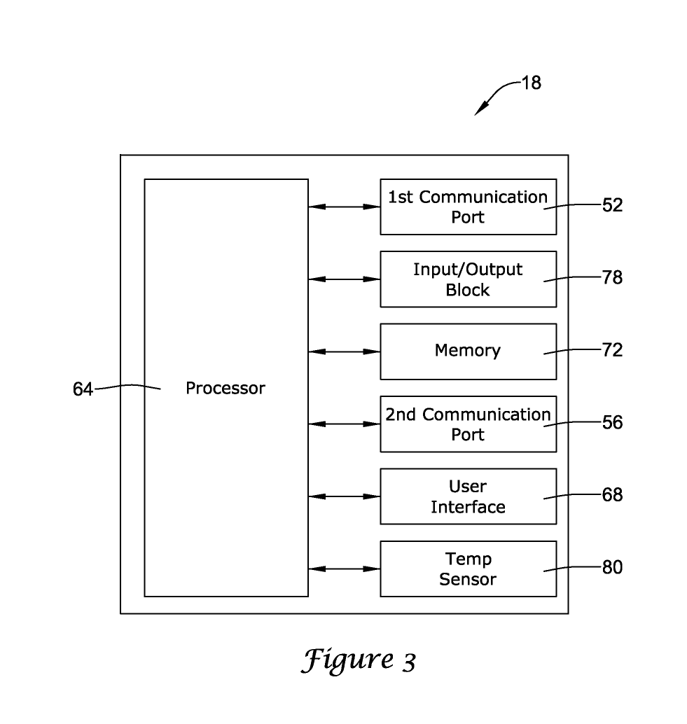

As shown in FIG. 2 and FIG. 3, the HVAC controller 18 may include a first input/output port 52 for communicating over a first network 54, and in some cases, a second input/output port 56 for communicating over a second network 58. In some cases, the first network 54 (when provided) may be a wireless local area network (LAN), and the second network 58 (when provided) may be a telecommunications network, cellular network, a wide area network or global network (WAN) including, for example, the Internet. In some cases, the wireless local area network 54 may provide a wireless access point and/or a network host device that is separate from the HVAC controller 18. In other cases, the wireless local area network 54 may provide a wireless access point and/or a network host device that is part of the HVAC controller 18. In some cases, the wireless local area network 54 may include a local domain name server (DNS), but this is not required for all embodiments. Additionally, in some cases, the wireless local area network 54 may be an ad-hoc wireless network, but this is not required. In some cases, the first network 54 and/or second network 58 may be a wired network.

Depending upon the application and/or where the HVAC user is located, remote access and/or control of the HVAC controller 18 may be provided over the first network 54 and/or the second network 58 via one or more remote devices 60, 62 including, but not limited to, mobile phones including smart phones, PDAs, tablet computers, laptop or personal computers, servers, e-Readers, and/or the like. In some cases, as shown in FIG. 2, more than one remote device 60 and 62 may be used to access and/or control the HVAC controller 18 from a remote location. For example, an HVAC user such as a home or business owner, may utilize a first remote device 60 and an HVAC installer or service technician may use a second remote device 62 to interact with the HVAC controller 18 from a remote location. Additionally, it will be generally understood that while the first remote device 60 and the second remote device 62 may (or may not) be the same type of device, the first remote device 60 and the second remote device 62 may be used to interact with the HVAC controller 18 in a different manner. In many cases, the remote devices 60, 62 may be configured to communicate wirelessly over the first network 54 and/or second network 58 with the HVAC controller 18 via one or more wireless communication protocols including, but not limited to, cellular communication, ZigBee, REDLINK™, Bluetooth, WiFi, IrDA, dedicated short range communication (DSRC), EnOcean, and/or any other suitable common or proprietary wireless protocol, as desired. In some cases, the remote devices 60, 62 may include a wired device, such as a personal computer, server, or other device with a wired connection to the first network 54 and/or second network 58.

In some cases, the HVAC controller 18 may be programmed to communicate over the second network 58 with an external web service hosted by one or more external web servers 66. A non-limiting example of such an external web service is Honeywell's TOTAL CONNECT™ web service. The HVAC controller 18 may be configured to upload selected data via the first network 54 and/or second network 58 to the external web service where it may be collected and stored on the external web server 66. In some cases, the data may be indicative of the performance of at least one of the HVAC components 6 of the HVAC system 4. Additionally, the HVAC controller 18 may be configured to send and/or receive selected data, configuration information, settings and/or services including software updates from the external web service, over the first network 54 and/or second network 58. The data, configuration information, settings and/or services may be sent and/or received automatically, periodically in accordance with a control algorithm, and/or on demand in response to a user request. In some cases, for example, the HVAC controller 18 may be configured to send and/or receive an HVAC operating schedule and operating parameter settings such as, for example, temperature setpoints, humidity set points, start times, end times, schedules, window frost protection settings, and/or the like. In some instances, the HVAC controller 18 may be configured to receive one or more user profiles having at least one operational parameter setting that is selected by and reflective of a user's preferences. Additionally, the HVAC controller 18 may be configured to receive local weather data, weather alerts and/or warnings, major stock index ticker data, and/or news headlines over the second network 58.

In some cases, the HVAC controller 18 may be configured to transmit at least a first data package, sometimes including information that is, at least in part, indicative of a measure of performance of one or more components of an HVAC system, as will be further described below. The phrase “first data package” does not necessarily mean that the data package is the “first” data package that is transmitted by the HVAC controller 18 in response to a request for service. Rather, the term “first” is used to distinguish the data package from a “second data package” that may be subsequently transmitted to the HVAC controller 18. Example information in the first data package may include one or more of a request for service, a system alert, a system error, a system configuration parameter, a measured HVAC parameter, a system performance log, a user interaction log, user's information such contact information, equipment type and/or any other suitable information. The first data package may be transmitted by the HVAC controller 18 in a computer readable format such that it may be accessed and viewed by an HVAC service provider such as, for example, an HVAC installer, service technician, or HVAC manufacturer. The first data package may be made accessible to an HVAC service provider at a web server or other remote device. In some cases, the first data package is transmitted in response to a request for service initiated by a user, an installer and/or manufacturer, as desired.

FIG. 3 is a schematic view of an illustrative HVAC controller 18 that may be accessed and/or controlled from a remote location over the first network 54 and/or the second network 58 (FIG. 2) using, for example, a remote device 60 and/or 62 such as, for example, a smart phone, a PDA, a tablet computer, a laptop or personal computer, an e-Reader, and/or the like. In some cases, the HVAC controller 18 may also be accessed and/or controlled via a server such as, for example, web server 66. As shown in FIGS. 2 and 3, the illustrative HVAC controller 18 may include a first input/output port 52 for communicating over a first network (e.g. wireless LAN) and/or a second input/output port 56 for communicating over a second network (e.g. WAN or the Internet). The first input/output port 52 can be a wireless input/output port including a wireless transceiver for wirelessly sending and/or receiving signals over a first wireless network 54. The second input/output port 56 may be a wireless input/output port including a wireless transceiver for sending and/or receiving signals over a second wireless network 58. In some cases, the second input/output port 56 may be in communication with a wired or wireless router or gateway for connecting to the second network, but this is not required. The router or gateway may be integral to the HVAC controller 18 or may be provided as a separate device. In some cases, the HVAC controller 18 may be a thermostat and more particularly, a wireless thermostat, but this is not required.

The illustrative HVAC controller 18 of FIG. 3 includes a processor (e.g. microprocessor, microcontroller, etc.) 64 coupled to the input/output ports 52, 56, and a memory 72. The HVAC controller 18 may also include a user interface 68 accessible at the HVAC controller 18, but this is not required. In some cases, the user interface 68 may be a virtual user interface and may be accessible to a remote device such as, for example, remote device 60 and/or 62. In some cases, the user interface 68 may include one or more web pages served up by a web server such as, for example, web server 66 (and/or a web server hosted by HVAC controller 18 itself) that may then be accessed and/or viewed using another remote device 60 and/or 62, as described herein.

The memory 72 of the illustrative HVAC controller 18 may be in communication with the processor 64. The memory 72 may be used to store any desired information, such as the aforementioned control algorithm, set points, schedule times, diagnostic limits such as, for example, differential pressure limits, delta T limits, HVAC configuration information, performance data logs, alert history logs, user interaction logs, HVAC service provider information, and/or the like. The memory 72 may be any suitable type of storage device including, but not limited to, RAM, ROM, EPROM, flash memory, a hard drive, and/or the like. In some cases, the processor 64 may store information within the memory 72, and may subsequently retrieve the stored information from the memory 72.

In some cases, the HVAC controller 18 may also include a timer (not shown). The timer may be integral to the processor 64 or may be provided as a separate component. The HVAC controller 18 may also optionally include an input/output block (I/O block) 78 for receiving one or more signals from the HVAC system 4 and/or for providing one or more control signals to the HVAC system 4. For example, the I/O block 78 may communicate with one or more HVAC components 6 of the HVAC system 4. Alternatively, or in addition to, the I/O block 78 may communicate with another controller, which is in communication with one or more HVAC components of the HVAC system 4, such as a zone control panel in a zoned HVAC system, equipment interface module (EIM) (e.g. EIM 34 shown in FIG. 1) or any other suitable building control device.

In some cases, the HVAC controller 18 may also include an internal temperature sensor 80. In addition or in alternative to, the HVAC controller 18 may communicate with one or more remote temperature sensors, humidity sensors, and/or occupancy sensors located throughout the building or structure. In some cases, for example, the HVAC controller 18 may communicate with a temperature sensor and/or humidity sensor located outside of the building or structure for sensing an outdoor temperature and/or humidity if desired.

During normal and/or routine operation, the processor 64 may operate in accordance with an algorithm that controls or at least partially controls one or more HVAC components of an HVAC system such as, for example, HVAC system 4 shown in FIG. 1. The processor 64, for example, may operate in accordance with a control algorithm that provides temperature set point changes, humidity set point changes, schedule changes, start and end time changes, window frost protection setting changes, operating mode changes, and/or the like. At least a portion of the control algorithm may be stored locally in the memory 72 of the HVAC controller 18 and, in some cases, may be received from an external web server 66 over the second network 58. The control algorithm (or portion thereof) stored locally in the memory 72 of the HVAC controller 18 may be periodically updated in accordance with a predetermined schedule (e.g. once every 24 hours, 48 hours, 72 hours, weekly, monthly, etc.), updated in response to any changes to the control algorithm made by a user, and/or updated in response to a user's request. The updates to the control algorithm or portion of the control algorithm stored in the memory 72 may be received from an external web service 66 over the second network 58. In some cases, the control algorithm may include settings such as set points, configuration parameters and the like.

In some cases, the processor 64 may operate according to a first operating mode having a first temperature set point, a second operating mode having a second temperature set point, a third operating mode having a third temperature set point, and/or the like. In some cases, the first operating mode may correspond to an occupied mode and the second operating mode may correspond to an unoccupied mode. In some cases, the third operating mode may correspond to a holiday or vacation mode wherein the building or structure in which the HVAC system 4 is located may be unoccupied for an extended period of time. In other cases, the third operating mode may correspond to a sleep mode wherein the building occupants are either asleep or inactive for a period of time. These are just some examples. It will be understood that the processor 64 may be capable of operating in additional modes as necessary or desired. The number of operating modes and the operating parameter settings associated with each of the operating modes may be established locally through a user interface, and/or through an external web service and delivered to the HVAC controller via the second network 58 where they may be stored in the memory 72 for reference by the processor 64.

In the illustrative embodiment of FIG. 3, the user interface 68, when provided, may be any suitable user interface that permits the HVAC controller 18 to display and/or solicit information, as well as accept one or more user interactions with the HVAC controller 18. For example, the user interface 68 may permit a user to locally enter data such as temperature set points, humidity set points, starting times, ending times, schedule times, diagnostic limits, responses to alerts, configuration parameter value selections,and/or the like. Additionally, the user interface 68 may permit a user to initiate a request for service from an HVAC service provider. In one embodiment, the user interface 68 may be a physical user interface that is accessible at the HVAC controller 18, and may include a display and/or a distinct keypad. When provided, the display may be any suitable display. In some instances, a display may include or may be a liquid crystal display (LCD), and in some cases a fixed segment display or a dot matrix LCD display. In other cases, the user interface 68 may be a touch screen LCD panel that functions as both display and keypad. The touch screen LCD panel may be adapted to solicit values for a number of operating parameters and/or to receive such values, but this is not required. In still other cases, the user interface 68 may be a dynamic graphical user interface.

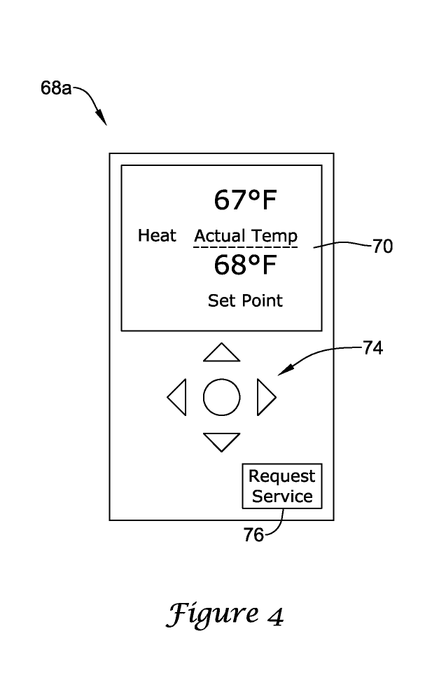

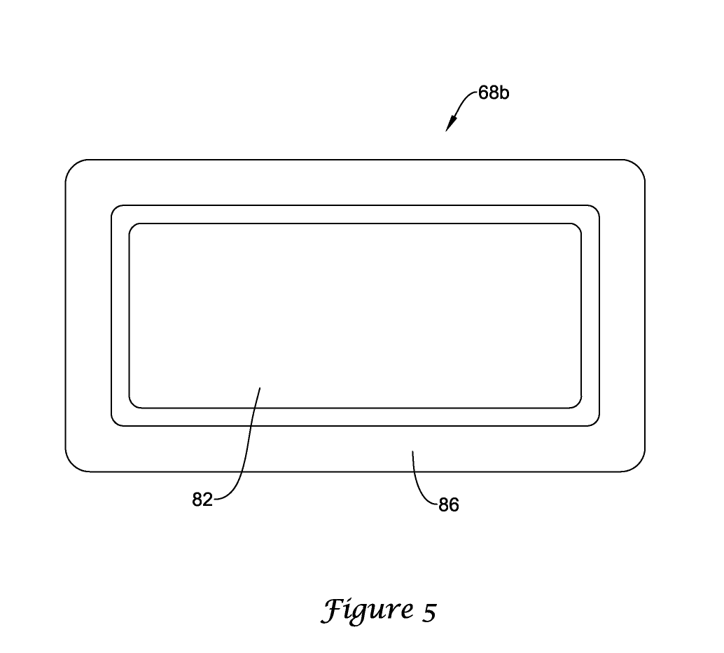

FIGS. 4 and 5 are schematic views of illustrative user interfaces 68A and 68B that may be physically accessible to a user at the HVAC controller 18. In some cases, a user may initiate a request service through the user interfaces 68A and/or 68B provided at the HVAC controller 18. As shown in FIG. 4, the example user interface 68A may include a display 70 and one more buttons 74, 76 adjacent the display. The buttons 74 may be used by a user to adjust and/or select temperature set points, humidity set points, starting times, ending times, schedule times, diagnostic limits, configuration parameter value selections, respond to alerts, and/or the like. In some cases, such as shown in the illustrative example provided in FIG. 4, the user interface 68A may include at least one button 76 labeled “Service”, “Service Request”, “Request Service” and/or the like, that a user may select to initiate a request for service via the user interface 68A of the HVAC controller 18. In some cases, an image representative of a service request such as a telephone receiver or other similar image may be used to indicate that the button 76 may be selected by a user to initiate a service request.

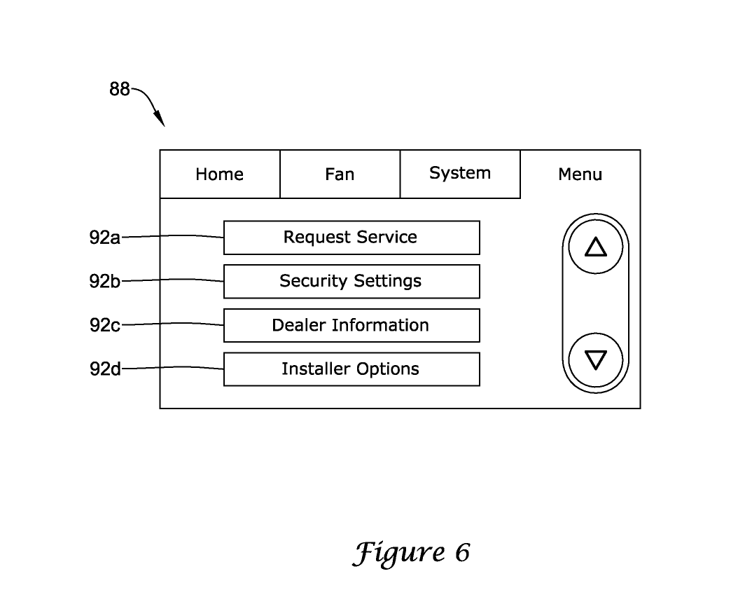

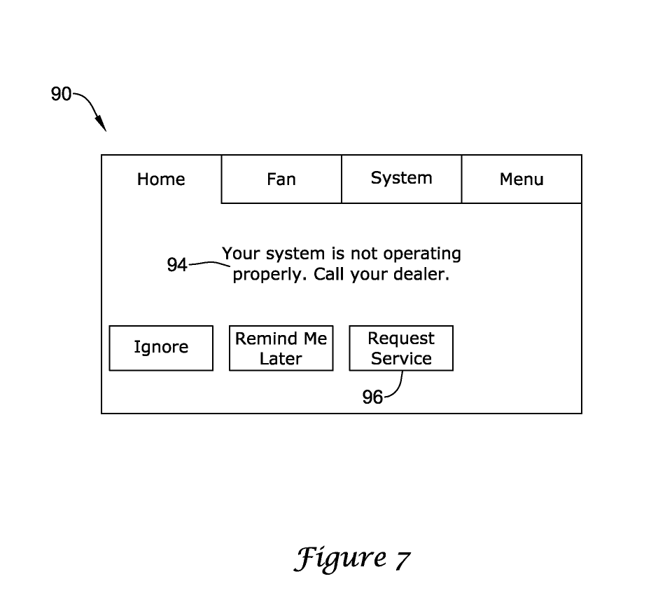

In the illustrative example of FIG. 5, the user interface 68B may include a display 82 that is disposed within a housing 86 but viewable externally from the housing 86. In some cases, display 82 may be a touch screen LCD display. If desired, display 82 may be a dot matrix touch screen LCD display. A dot matrix touch screen LCD display is a touch screen LCD that permits images such as letters, numbers, graphics, images, and the like to be displayed anywhere on the LCD, rather than being confined to predetermined locations such as is the case with a fixed segment type of LCD display. FIGS. 6 and 7 provide exemplary screens 88, 90 that may be displayed on the display 82 of FIG. 5 forming at least a part of the user interface 68B of an exemplary HVAC controller such as, for example HVAC controller 18. As shown in FIG. 6, screen 88 may include one or more selectable options 92a-92d displayed on the display 82 for selection by a user. In some cases, as shown, the one or more selectable options 92a-92d may be displayed on a menu screen or other similar screen. At least one of the selectable options 92a-92d such as, for example, option 92a labeled “Request Service” may cause the processor 64 of the HVAC controller 18 to initiate a request for service when selected by a user. In some cases, as shown in the illustrative example of FIG. 7, screen 90 may be a home screen. In one instance, the processor 64 may be configured to display an alert 94 or other message on screen 90 when the HVAC system is not operating properly and/or the processor determines that service may be needed. In addition to the alert 94 or message, the processor 64 may be configured to display at least one individually selectable option 96 labeled “Request Service” or “Service Request” on screen 90 that, when selected by a user, may cause the processor 64 to initiate a request for service from a service provider. While in some instances the request for service may be initiated by a user in response to an alert or error message, it will be generally understood by those of skill in the art, that a request for service may be initiated at any time by a user via the user interface of the HVAC controller according to the various embodiments as described herein.

In some instances, the user interface 68 need not be physically accessible to a user at the HVAC controller 18. Instead, the user interface 68 may be a virtual user interface 68 that is accessible via the first network 54 and/or second network 58 using a remote device such as one of those devices previously described herein. The virtual user interface 68 may include and display HVAC controller related information. The HVAC controller related information may relate to performance of one or more components 6 of the HVAC system 4, and may include a system alert, a system error, an error code, a system configuration parameter, a user interaction log (or a portion thereof), a performance data log (or a portion thereof), a system alert log (or a portion thereof), a measured HVAC parameter, and/or the like. Additionally, the HVAC related information may include HVAC service provider information such as a contact name, phone number, web site, and/or email address of the user's HVAC service provider. The service provider may be an HVAC contractor, an HVAC manufacturer, or any other suitable service provider, as desired.

In some cases, the virtual user interface 68 may be provided by an application program code that when executed by a remote device 60 and/or 62 causes the remote device 60 and/or 62 to display the HVAC controller related information and/or in addition, facilitate a user's interactions with the HVAC controller 18. In some cases, the screens displayed on the virtual user interface provided by the remote device 60 and/or 62 may be similar to those screens displayed on a HVAC controller 18 having a touch screen display as described herein with reference to FIGS. 5-7. In other cases, the HVAC controller related information may be displayed by one or more web pages that are provided over the first network 54 (e.g. LAN) by an internal web server implemented by the processor 64 or, alternatively, over the second network 58 (e.g. WAN or the Internet) by an external web server (e.g. web server 66). When so provided, the virtual user interface 68 may be accessed over the first network 54 and/or second network 58 using a remote device 60 or 62 such as any one of those listed above. In one instance, the one or more web pages forming the virtual user interface 68 may be hosted by an external web service and associated with a user account having one or more user profiles. The external web server 66 may receive and accept any user inputs entered via the virtual user interface 68 and associate the user inputs with a user's account on the external web service hosted by the external web server 66. If the user inputs include any changes to the existing control algorithm including any temperature set point changes, humidity set point changes, schedule changes, start and end time changes, window frost protection setting changes, operating mode changes, configuration parameter value changes, and/or changes to a user's profile, the external web server may update the control algorithm, as applicable, and transmit at least a portion of the updated control algorithm over the second network 58 to the HVAC controller 18 where it is received via the second input/output port 56 and may be stored in the memory 72 for execution by the processor 64. Additionally, the external web server 66 may receive any data uploaded by a user from the HVAC controller 18 and associate the uploaded data with the user's account on the external web service hosted by the external web server 66.

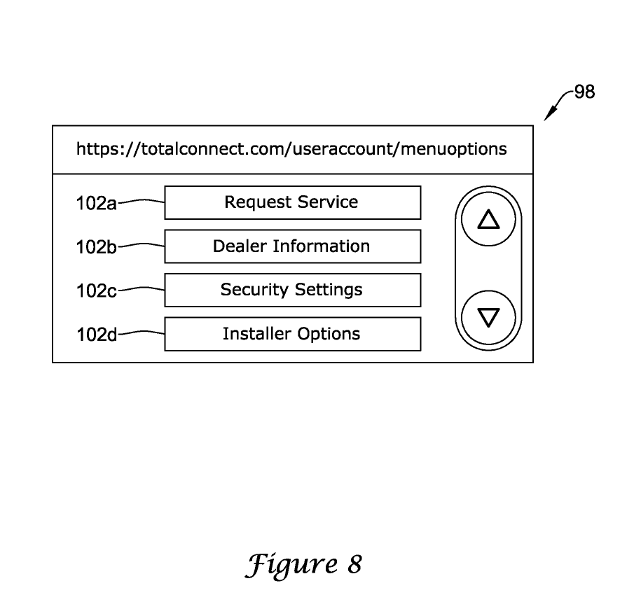

FIG. 8 is an example web page 98 that may form at least a part of a virtual user interface 68 that may be accessed and viewed via one of the remote devices 60 and/or 62 as described herein. In one instance, the exemplary web page 98 may be served up by an external web server 66 as shown in FIG. 2. Alternatively, the exemplary web page 98 may be served up by a web server built into the HVAC controller 18. As shown in FIG. 8, the web page 98 may display one or more selectable options 102a-102d for selection by a user. In some cases, the selectable options 102a-102d, when selected by a user, may permit a user to locally enter data such as temperature set points, humidity set points, starting times, ending times, schedule times, diagnostic limits, responses to alerts, configuration parameter value selections, and/or the like. In one instance, as shown in the illustrative example of FIG. 8, at least one of the selectable options 102a, may permit a user initiate a request for service from a service provider through the virtual user interface 68.

Upon receiving a request for service from a user via the user interface 68 (either real or virtual), the processor 64 may be configured to transmit at least a first data package containing information that may be indicative, at least in part, of a measure of performance of one or more

HVAC components 6 of the HVAC system 4. The processor 64 may be configured to transmit the first data package in a computer readable format, ultimately to a service provider. The computer readable form may include any number of computer readable languages that may be interpreted and executed by a processor (e.g. microcontroller, microprocessor, etc.) of a remote device that receives the configuration parameter data package including, but not limited to, the following: html, xhtml, xml, binary, and/or any other suitable computer readable form. In some cases, the first data package may include a text string for natural language programming. The information contained in the first data package may include, but is not limited to, a request for service, a system alert log (or a portion thereof), a system error, a system configuration parameter, a measured HVAC parameter, a system performance log (or a portion thereof), a user interaction log (or a portion thereof), user's information such contact information, equipment type and/or any other suitable information. The first data package may also contain information about a user's account with the service provider. These are just some examples. In some cases, the processor 64 may first initiate one or more tests to generate some or all of the information that is provided in the first data package, but this is not required in all embodiments.

In some cases, the first data package may be transmitted to a server (e.g. web server 66) that is accessible by the service provider. The service provider may use a remote device (e.g. remote device 62) to access the web server 66 hosting the information, and to view the information contained within the first data package via one or more web pages served up by the web server 66. In other cases, the first data package may be delivered to a remote device used by the service provider over a network. For example, the first data package may be transmitted in a SMS text message or email message over a cellular telecommunications network (e.g. 3G or 4G network) or a wide area network such as the Internet to the service provider. Software utilized by the remote device may enable the service provider to view the information delivered in the first data package via the user interface of the remote device.

In some cases, the processor 64 may be configured to receive a second data package from a remote device including information indicating that the first data package was received by the service provider. The remote device may be any one of the remote devices as described herein including a web server. Upon receiving confirmation that the first data package was received by the service provider, the processor 64 may be programmed to provide an indication to the user via the user interface that the first data package was successfully sent.

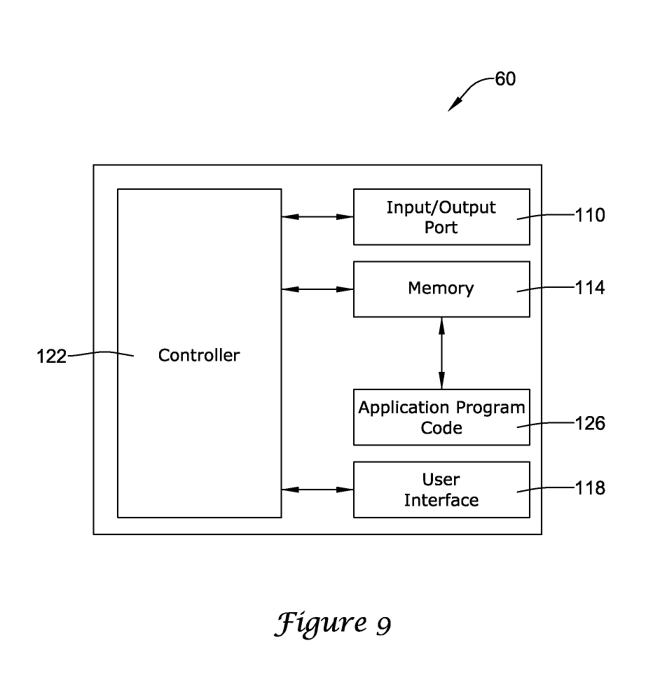

FIG. 9 is a schematic block diagram of a first remote device 60 that may be used to communicate with and/or control one or more HVAC controllers 18 located within a building or structure 2. In some cases, the first remote device 60 may be used by an HVAC user such as a homeowner or business owner to interact with one or more HVAC controllers 18 located within their home or business. The remote device 60 may be, for example, any one of the devices described herein. In some instances, the remote device 60 may be a smartphone or a tablet computer, but this is not required. As discussed above with reference to FIG. 2, the remote device 60 may be used to communicate with and, in some cases, control one or more HVAC controllers 18 located within the building or structure 2 via the first network 54 and/or second network 58 depending upon the application. In some cases, as described herein, the remote device 60 may be programmed to communicate over the second network 58 with an external web service hosted by one or more external web servers 66 to which the HVAC controller 18 is also connected. A non-limiting example of such an external web service is Honeywell's TOTAL CONNECT™ web service. When so provided, communication and data may be transmitted between the remote device 60 and the one or more HVAC controllers 18 via the external web service hosted by the one or more external web servers 66.

As shown in FIG. 9, the remote device 60 may include at least one wired and/or wireless input/output port 110 for sending and/or receiving data over the first and/or second network 54, 58 to and from the one or more HVAC controllers 18 located within the building 2. The illustrative remote device 60 may include a memory 114, a user interface 118 including a display, and a controller 122 (e.g. microprocessor, microcontroller, etc.) coupled to the input/output port 110, the memory 114, and the user interface 118. In some instances, one or more application program codes 126 may be stored in the memory 114 for execution by the controller 122 of the remote device 60. In some instances, the one or more application program codes 126 may be purchased and/or downloaded from an external web service such as, for example, Apple, Inc.'s ITUNES™, Google Inc.'s Google Play, and/or from some other external web service hosted by one or more external web servers 66 to which the one or more HVAC controllers 18 can be connected. In one instance, at least one of the application program codes 126 stored in the memory 114 may relate to controlling an HVAC system 4. Additionally, in some instances, at least one of the application program codes 126 stored in the memory 114 may relate to initiating a request for HVAC service. It some instances, the controller 122 of the remote device 60 may be capable of executing multiple application program codes 126 stored in the memory 114 for carrying out different functions.

In some cases, the controller 122 may execute an application program code 126 stored in the memory 114 that may permit a user to initiate a service request using the remote device 60. In other cases, a user may initiate a request for service via one or more web pages that may be displayed via the user interface 118 of the remote device 60. The one or more web pages may be served up by either the HVAC controller 18 or a web server such as web server 66, as described herein. In some instances, the request for service may be transmitted from the remote device 60 to the HVAC controller 18 via the input/output port 110, such that it is deliverable to an HVAC controller 18 associated with the user. In some cases, the request for service may be transmitted from the remote device 60 directly to the HVAC controller 18. In other cases, the remote device 60 may first transmit the request for service to a remote server, such as for example, web server 66 of FIG. 2. The request for service may be then subsequently delivered to the HVAC controller 18 from the server 66. These are just some examples.

Upon receiving the request for service from the user's remote device 60, received either directly from the remote device 60 or via a server (e.g. web server 66), the processor 64 of the HVAC controller 18 may be configured to transmit at least a first data package to a service provider via the input/output port of the HVAC controller 18. The first data package may include a request for service and may also include information that is, at least in part, indicative of a measure of a performance of one or more components of the HVAC system 4. The information may include one or more of a system alert, a system error, a system configuration parameter, a measured HVAC parameter, a system performance log and/or a user interaction log. In some instances, the remote device 60 may be configured to receive an acknowledgement via the input/output port 110 that the first data package sent by the HVAC controller 18 in response to receiving the request for service initiated by a user via the user interface 118 of the remote device 60 was received by a service provider. Upon receiving confirmation that the first data package was received by the service provider, the controller 122 may be further programmed to provide an indication to the user via the user interface 118 that the first data package was successfully sent.

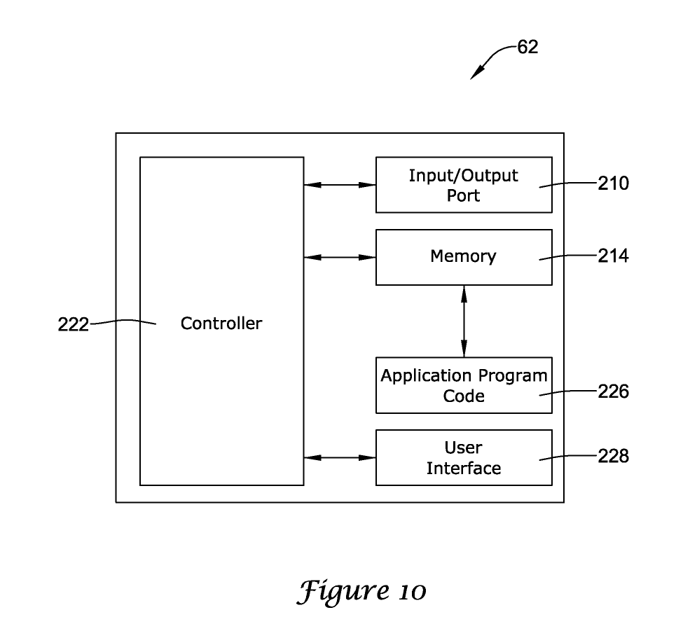

FIG. 10 is a schematic view of a second remote device 62 that may be used to communicate with and/or control one or more HVAC controllers 18 located within a building or structure 2. In some cases, the second remote device 62 may be used by an HVAC service provider to interact with one or more HVAC controllers 18 located within a building or structure 2 that is occupied by the service provider's client(s). The remote device 62 may be, for example, any one of the devices described herein. In some instances, the remote device 62 may be a smart phone, a tablet computer, a lap top computer, or a server, but this is not required. Additionally, while the second remote device 62 may be the same type of device as the first remote device 60 used by the HVAC user, it will be generally understood that the HVAC user and the service provider may use the first and second remote devices 60, 62, respectively, to interact with the HVAC controller 18 in a different manner.

As discussed above with reference to FIG. 2, the second remote device 62 may be used to communicate with and, in some cases, control one or more HVAC controllers 18 located within the building or structure 2 via the first network 54 and/or second network 58 depending upon the application. In some cases, as described herein, the second remote device 62 may be programmed to communicate over the second network 58 with an external web service hosted by one or more external web servers 66 to which the HVAC controller 18 is also connected. A non-limiting example of such an external web service is Honeywell's TOTAL CONNECT™ web service. When so provided, communication and data may be transmitted between the remote device 62 and the one or more HVAC controllers 18 via the external web service hosted by the one or more external web servers 66.

As shown in FIG. 10, the remote device 62 may include at least one wired and/or wireless input/output port 210 for sending and/or receiving data over the first and/or second network 54, 58 to and from the one or more HVAC controllers 18 located within the building 2. The illustrative remote device 62 may include a memory 214, a user interface 218 including a display, and a controller 222 (e.g. microprocessor, microcontroller, etc.) coupled to the input/output port 210, the memory 214, and the user interface 218. In some instances, one or more application program codes 226 may be stored in the memory 214 for execution by the controller 222 of the remote device 60. In some instances, the one or more application program codes 226 may be purchased and/or downloaded from an external web service such as, for example, Apple, Inc.'s ITUNES™, Google Inc.'s Google Play, and/or from some other external web service hosted by one or more external web servers 66 to which the one or more HVAC controllers 18 can be connected. In some cases, the controller 222 of the remote device 62 may be capable of executing multiple application program codes 226 stored in the memory 214 for carrying out different functions. In one instance, at least one of the application program codes 226 stored in the memory 214 may relate to controlling an HVAC system 4. Additionally, in some instances, at least one of the application program codes 226 stored in the memory 214 may relate to confirming that a service request has been received from an HVAC user and viewing information indicative of a performance of an HVAC system 4 contained in the service request. The information indicative of performance may be displayed on the service provider's remote device 62 in a graphical or tabular format, if desired. The application program code 226 related to confirming that a service request has been received may also be used to make changes to view any information included with the service request such as, for example, a measure indicative of a performance of the user's HVAC system 4.

In some cases, at least one application program code 226 may cause the controller 222 to analyze the information contained within the first data package received from the HVAC controller 18 and to determine based, at least in part, on the information contained in the first data package that the HVAC system 4 needs maintenance. Upon determining that the HVAC system 4 may need maintenance, the controller 222 may execute additional application program code related to scheduling a maintenance visit and/or to initiating diagnostic testing of the user's HVAC system 4 from the service provider's remote device 62. In one instance, for example, the acknowledgement transmitted by the service provider's remote device 62 confirming that the service request was received may include a user query asking the user to indicate a window of time in which the HVAC controller 18 may run a diagnostic test on the user's HVAC system 4. The service provider may then chose to initiate one or more diagnostic tests on the user's HVAC system 4 within the time window specified by the HVAC user in an attempt to minimize any inconvenience to the HVAC user. In other cases, the acknowledgement transmitted by the service provider's remote device 62 confirming that the service request was received may include instructions that cause one or more diagnostic tests to be performed on the user's HVAC system 4 and to return the results to the service provider.

The service provider may transmit a command to the HVAC controller 18 via the user interface 218 of their remote device 62 to initiate testing of at least one HVAC component 6 of the HVAC system. In some cases, the command may be transmitted directly to the HVAC controller 18, while in other cases, the command may be transmitted to a web server, which may then provide the test to the HVAC controller 18. In either case, the command transmitted from the service provider's remote device 62, when received by the HVAC controller 18, may cause the HVAC controller 18 to initiate the testing of the at least one HVAC component and, in some cases, to generate and transmit a test result back to the service provider's remote device 62. The test result may be transmitted directly to the service provider's remote device via a network or, in some cases, the test result may be transmitted from the HVAC controller 18 to the service provider's remote device via a server such as, for example, web server 66. The service provider may access and view any test results generated as a result of the diagnostic testing through the user interface 118 of their remote device 62.

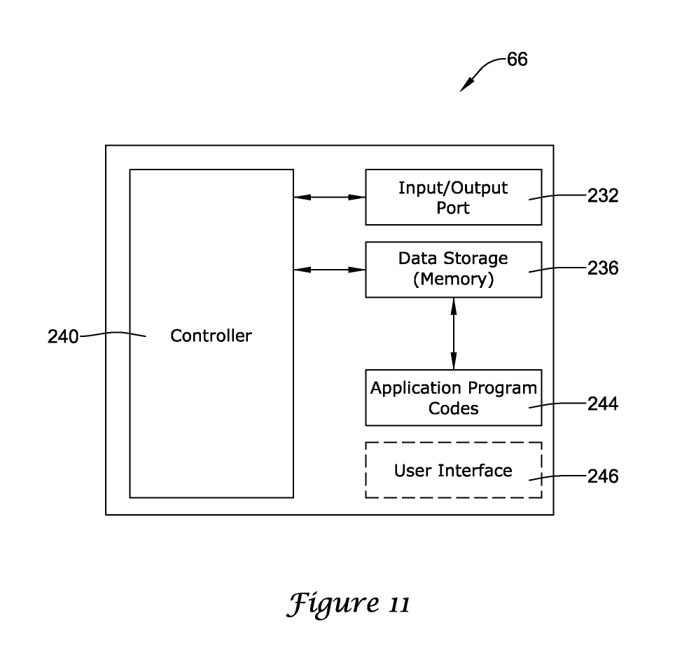

In some cases, as described herein, both the first remote device 60 (the HVAC user's remote device) and/or the second remote device 62 (the service provider's remote device) may be configured to communicate with one or more HVAC controllers 18 via a web server such as, for example, web server 66 of FIG. 2. FIG. 11 is a schematic block diagram of an illustrative web server 66 that may be used to facilitate communication between one or more remote devices 60, 62 and one or more HVAC controllers 18 located within a building or structure 2. As shown in FIG. 11, web server 66 may include an input/output port 232 for communicating with one or more remote devices 60, 62 over a wide area network (e.g. the second network 58 of FIG. 2), a data storage device 236, a controller 240 coupled to the input/output port 232 and the data storage device 236, and an optional user interface. In some cases, a plurality of application program codes 244 may be stored on the data storage device 236 for execution by the controller 240. In one instance, at least one of the application program codes 244, when executed by the controller 240, may relate to serving up one or more web pages over the second network 58 that may be accessible to a user using a remote device 60 and/or 62, and that may form at least a part of a virtual user interface 68, as described herein, for interacting with an HVAC controller 18.

In some cases, the controller 240 may be configured to receive a first data package from an HVAC controller 18 in control of one or more HVAC components 6 of an HVAC system 4 over a network such, as for example, the second network 58. The first data package, as described herein, may include a request for service from a service provider, and in some cases, may also include information that is indicative of a performance of at least one or more components 6 of the HVAC system 4. Additionally, the controller 240 may be configured to make the information contained in the first data package available to a service provider over a network such as, for example, the second network 58. The information contained in the first data package may be displayed via one or more web pages served up by the controller 240 over the second network 58. The service provider may use a remote device such as, remote device 62 as described herein, to access and view the one or more web pages containing the information contained within the first data package transmitted by the HVAC controller 18. In other cases, rather than displaying the information contained within the first data package via one or more web pages, the server 66 may receive the first data package from the HVAC controller 18, associate the first data package with the user's account on a web service hosted by the web server 66, and then relay the first data package to a service provider associated with the user's account. In this instance, both the HVAC user and the service provider may be registered with the same web service hosted by the web server 66 and may, in some cases, be associated with one another. In other cases, if no service provider is associated with a user's account, the controller 240 may be configured to determine the closest service provider to the user that is registered with the web service, and may then transmit the first data package to that service provider.

In addition, the controller 240 may be configured to transmit a second data package over the network (e.g. second network 58) to the HVAC controller 18. The second data package may include information confirming that the first data package was received by the server 66. In addition, the second data package may include information confirming that the first data package was then received by a service provider. In some cases, for example, upon receiving the first data package containing a request for service, the service provider may transmit a response to the HVAC controller 18 confirming that the first data package was received. In some cases, the service provider may transmit their response to the HVAC controller 18 via the server 66. The controller 240 may receive the response confirming that the first data package was received by the service provider and may associate this information with the HVAC user's account on a web service hosted by the server 66. The controller 240 may then transmit the second data package including the acknowledgement that the request for service was received by the service provider over the second network 58 to the HVAC controller 18. The HVAC controller 18 may be configured to display a message to the user via the user interface (either virtual or real) of the HVAC controller 18 that the first data package including the request for service was received by the service provider.

In some cases, at least one application program code 244 stored on the data storage device 236 may cause the controller 240 to analyze the information contained within the first data package received from the HVAC controller 18 and to determine based, at least in part, on the information contained in the first data package, that the HVAC system 4 needs maintenance. Upon determining that the HVAC system 4 may need maintenance, the controller 240 may execute additional application program codes 244 related to scheduling a maintenance visit and/or to initiating diagnostic testing of at least one component 6 of the user's HVAC system 4. In one instance, for example, the controller 240 may be configured to transmit an acknowledgement confirming that the service request was received by a service provider. In some cases, the acknowledgement may include a user query asking the user to indicate a window of time in which to run a diagnostic test on the user's HVAC system 4. Upon receiving a user's selected time window at the web server, the controller 240 may chose to initiate diagnostic tests of the user's HVAC system 4 within the time window specified by the HVAC user to minimize any inconvenience to the HVAC user. The controller 240 may transmit a command to the HVAC controller 18 to initiate the diagnostic testing of at least one HVAC component 6 of the HVAC system. The command transmitted from the controller 240 via the input/output port 232, when received by the HVAC controller 18, may cause the HVAC controller 18 to initiate the designated tests and to generate and transmit a test result back to the server 66. In some cases, the service provider may designate which tests to run. Alternatively, or in addition, the application program code on the server 66 may determine one or more of the tests based on the information contained in the first data package. In any event, the controller 240 may be configured to serve up one or more web pages including the test result that may be accessed and viewed by a service provider through the user interface 118 of the service provider's remote device 62.

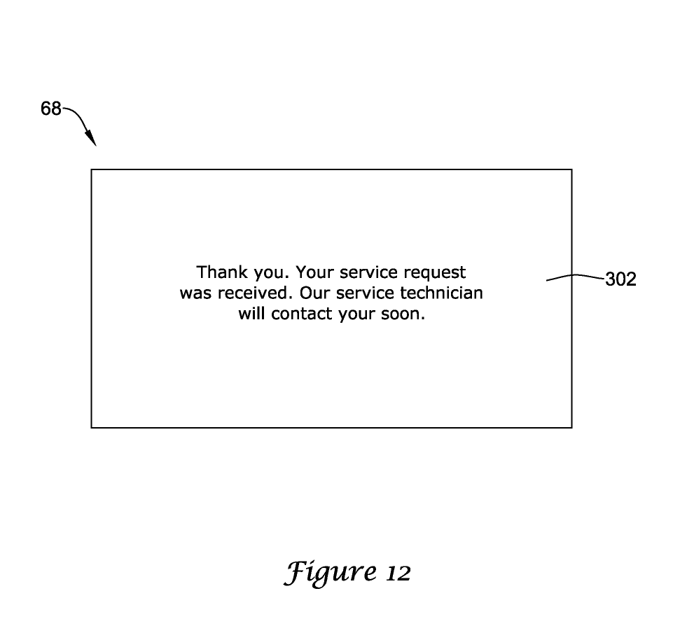

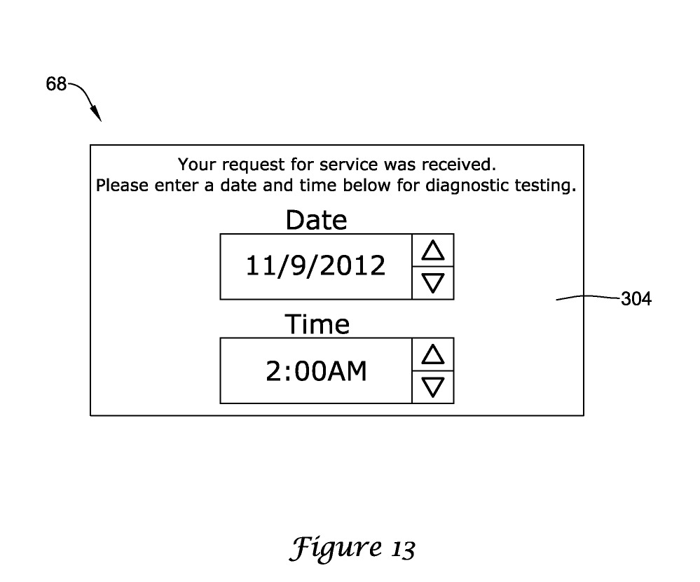

FIG. 12 provides an illustrative example of a user message 302 that may be displayed to an HVAC user by the user interface 68 (either virtual or real) of the HVAC controller 18 confirming that the first data package including a request for service transmitted by the HVAC controller 18 was received by a service provider. The user message 302 may be provided in a natural language format that may be intuitive and easily understood by the user. For example, the user message may state that “Your service request was received. Our service technician will contact you soon”. FIG. 13 provides another illustrative example of a user message 304 that may be displayed to an HVAC user by the user interface 68 (virtual or real) of the HVAC controller 18. As shown in the illustrative example of FIG. 13, the user message 304 may include an acknowledgement confirming that the first data package including a request for service transmitted by the HVAC controller 18 was received by the service provider. In addition, the user message 304 may prompt the user to enter a date and a time in which diagnostic testing may be conducted.

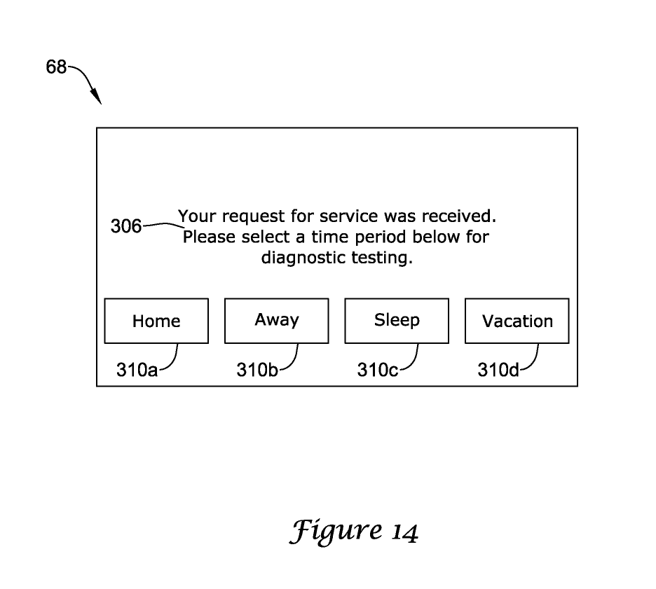

FIG. 14 provides yet another illustrative example of a user message 306 that may be displayed to an HVAC user by the user interface 68 (either virtual or real) of the HVAC controller 18. In this example, the user message 306 includes an acknowledgement confirming that the first data package including a request for service transmitted by the HVAC controller 18 was received by the service provider. In addition, the user message 306 may also prompt the user to select a time period 3010a-310d from one or more available time periods in which to initiate diagnostic testing. In some instances, the time periods 310a-310d may correspond to at least one of the time periods, home, away, sleep and/or vacation, of a user's programmed HVAC operating schedule.

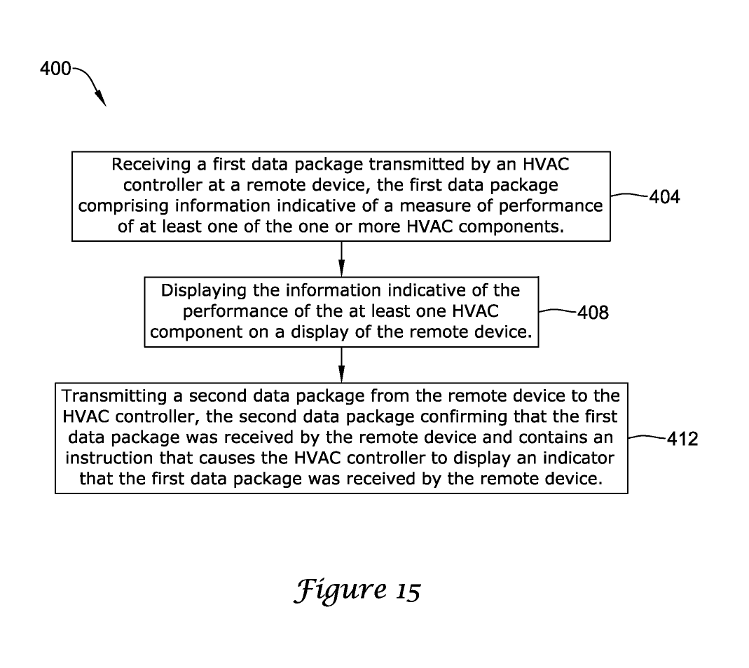

FIG. 15 is a flow chart of a method 400 of testing an HVAC system including an HVAC controller, as described herein, in control of one of more HVAC components. In one instance, the method 400 includes receiving a first data package transmitted by an HVAC controller 18 at a remote device such as, for example, remote device 62 or server 66 (Block 404). The first data package may include information indicative of a measure of performance of at least one of the one or more HVAC components. The information indicative of the performance of at least one of the HVAC components may then be displayed on the display of the remote device (Block 408). In addition, the first data package may also include a request for service from a service provider. In response to receiving the first data package from the HVAC controller 18, the remote device may transmit a second data package confirming that the first data package was received by the remote device (Block 412). In some cases, the second data package may contain an instruction that causes the HVAC controller 18 to display an indicator to the user that the first data package was received by the remote device.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respect, only illustrative. Changes may be made in details, particularly in matters of shape, size, and arrangement of parts without exceeding the scope of the disclosure. The disclosure's scope is, of course, defined in the language in which the appended claims are expressed.

What is claimed is:

1. An HVAC controller for controlling one or more HVAC components of an HVAC system, comprising:
an input/output port for sending and/or receiving information over a network;
a memory;
a user interface; and
a controller coupled to the input/output port, the memory and the user interface, the controller configured to receive a request for service from a user via the user interface, wherein upon receiving the request for service, the controller transmits a first data package to a service provider via the input/output port of the HVAC controller, wherein the first data package includes information that is, at least in part, indicative of a measure of performance of one or more components of the HVAC system.

2. The HVAC controller of claim 1, wherein the HVAC controller is a wireless thermostat, wherein the input/output port includes a wireless input/output port.

3. The HVAC controller of claim 1, wherein the user interface includes a button, and the controller receives the requesting for service from a user via the button.

4. The HVAC controller of claim 1, wherein the user interface includes a touch screen display, and the controller receives the requesting for service from a user via the touch screen display.

5. The HVAC controller of claim 1, wherein the controller transmits the first data package to a server accessible by the service provider.

6. The HVAC controller of claim 1, wherein the controller transmits the first data package in a SMS message to the service provider.

7. The HVAC controller of claim 1, wherein the service provider is one or more of an HVAC contractor and an HVAC manufacturer.

8. The HVAC controller of claim 1, wherein the information of the first data package includes one or more of a system alert, a system error, an error code, a system configuration parameter, a measured HVAC parameter and a user interaction log.

9. The HVAC controller of claim 1, wherein the information comprises data about a user's account with the service provider.

10. The HVAC controller of claim 1, wherein the controller is programmed to receive a second data package via the input/output port including information indicating that the first data package was received by the service provider.

11. The HVAC controller of claim 10, wherein in response to receiving the second data package, the controller is further programmed to indicate via the user interface that the first data package was received by the service provider.

12. A remote device configured to communicate with an HVAC controller in control of one or more components of an HVAC system, the remote device comprising:
an input/output port for sending and/or receiving information via a network;
a memory;
a user interface;
a controller coupled to the input/output port, the memory and the user interface, the controller configured to receive a requesting for service from a user via the user interface of the remote device, wherein upon receiving the requesting for service, the controller of the remote device transmits the request for service via the input/output port; and
the controller is further configured to receive an acknowledgement via the input/output port of the remote device that the request for service was sent to a service provider.

13. The remote device of claim 12, wherein the controller of the remote device transmits the request for service to a server, and the request for service is subsequently delivered to the HVAC controller via the server.

14. The remote device of claim 13, wherein the HVAC controller, in response to receiving the request for service from the server, transmits a data package, which includes information that is, at least in part, indicative of a measure of performance of one or more components of the HVAC system.

15. The remote device of claim 14, wherein, in response to receiving the data package, the service provider transmits the acknowledgement.

16. The remote device of claim 12, wherein the remote device is one or more of a smart phone, a tablet computer, a personal computer and an e-reader.

17. A computer readable medium having stored thereon in a non-transitory state software for use by a remote device connectable to a network, the software causing the remote device to execute a method comprising:
receiving a first data package over a network from an HVAC controller in control of one or more HVAC components of an HVAC system, the first data package comprising information indicative of a performance of at least one of the one or more components of the HVAC system;
making the information contained in the first data package available to a service provider; and
transmitting a second data package over the network to the HVAC controller, the second data package including information confirming that the first data package has been received by the remote device.

18. The computer readable medium of claim 17, wherein the remote device is any one of a cellular phone, a computer, or a server.

19. The computer readable medium of claim 17, wherein the method further comprises accepting a user input via a user interface of the remote device, the user input indicative of confirmation that the first data package transmitted by the HVAC controller was received.

20. The computer readable medium of claim 17, wherein the method further comprises analyzing the information contained within the first data package received from the HVAC controller, and determining based, at least in part, on the information contained within the first data package if the HVAC system needs maintenance.

21. The computer readable medium of claim 20, wherein the method further comprises scheduling a maintenance visit if it is determined that the HVAC system needs maintenance.

22. The computer readable medium of claim 17, wherein the method further comprises transmitting a command to the HVAC system for initiating a test of at least one HVAC component of the HVAC system, and reporting a test result.

23. A method for testing an HVAC system including an HVAC controller in control of one or more HVAC components, the method comprising;
receiving a first data package transmitted by an HVAC controller at a remote device, the first data package comprising information indicative of a measure of performance of at least one of the one or more HVAC components;
displaying the information indicative of the performance of the at least one HVAC component on a display of the remote device; and
transmitting a second data package from the remote device to the HVAC controller, the second data package confirming that the first data package was received by the remote device and contains an instruction that causes the HVAC controller to display an indicator that the first data package was received by the remote device.

24. The method of claim 23, wherein the first data package includes a request for service.
